(19) United States
(12) Patent Application Publication
(10) Pub. No.: US 2011/0185858 A1
(43) Pub. Date: Aug. 4, 2011

(54) Universal barrel opener

(76) Inventor: A-Fa Luo, Taichung (TW)

(21) Appl. No.: 12/700,254

(22) Filed: Feb. 4, 2010

(51) Int. Cl. B67B 7/44

(52) U.S. Cl. 81/3.09

(57) ABSTRACT

A barrel opener includes a handle (10); a first projection (20) on a first surface of the handle (10); a second projection (21) parallel to the first projection (20) on the first surface of the handle (10); a first protrusion (22) on one side of the handle (10); a second protrusion (23) parallel to the first protrusion (22) on one side of the handle (10); a prying member (30) on a second surface of the handle (10) opposite the first surface of the handle (10), the prying member (30) having an end hook (300); a fulcrum (31) spaced from the prying member (30) and on the second surface of the handle (10); and a protuberance (40) on one side of the prying member (30) opposing both the first and second protrusions (22, 23). The open is operable to open one of a variety of barrel caps or barrel tops.

### BACKGROUND OF THE INVENTION

1. Field of Invention

The invention relates to container openers and more particularly to a universal barrel opener adapted to open one of a variety of barrel caps or barrel tops.

2. Description of Related Art

A conventional 50 US gallons barrel may have two caps of different sizes. Typically, two different wrenches are employed to remove the caps from the openings of the barrel. This is inconvenient.

Moreover, there are a variety of containers commercially available and each container may have a specially shaped cap. This means that an employee may have to prepare many different types of wrenches in order to facilitate the opening or closing of the containers in work. This is not desirable. Hence, a need has arisen for a universal barrel opener in order to overcome the inadequacies of the prior art.

### SUMMARY OF THE INVENTION

It is therefore one object of the invention to provide a barrel opener includes an elongated handle; a first projection on a first surface of the handle; a second projection parallel to the first projection on the first surface of the handle; a first protrusion on one side of the handle; a second protrusion parallel to the first protrusion on one side of the handle; a prying member on a second surface of the handle opposite the first surface of the handle, the prying member having an end hook; a fulcrum spaced from the prying member and on the second surface of the handle; and a protuberance on one side of the prying member opposing both the first and second protrusions.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of universal barrel opener according to the invention;

FIG. 2 is an environmental view of the barrel opener being adapted to open a large first cap of one type of barrel;

FIG. 3 is an environmental view of the barrel opener being adapted to open a small second cap of the barrel;

FIGS. 4 and 5 are side elevations of the barrel opener and the barrel showing a removal of a top of another type of barrel;

FIG. 6 is another perspective view of the barrel opener but viewed from an opposite direction;

FIG. 7 is an environmental view of the barrel opener being adapted to open either one of two identical caps of still another type of barrel; and

FIGS. 8A, 8B, and 8C are top plan views of three different barrel caps which can be opened or closed by the barrel opener of the invention.

### DETAILED DESCRIPTION OF THE INVENTION

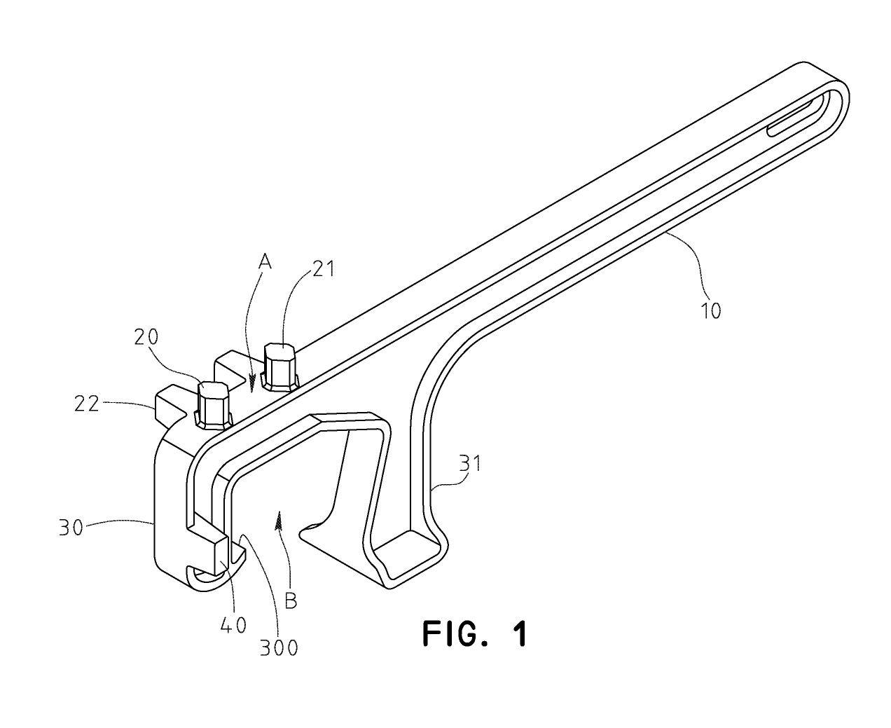

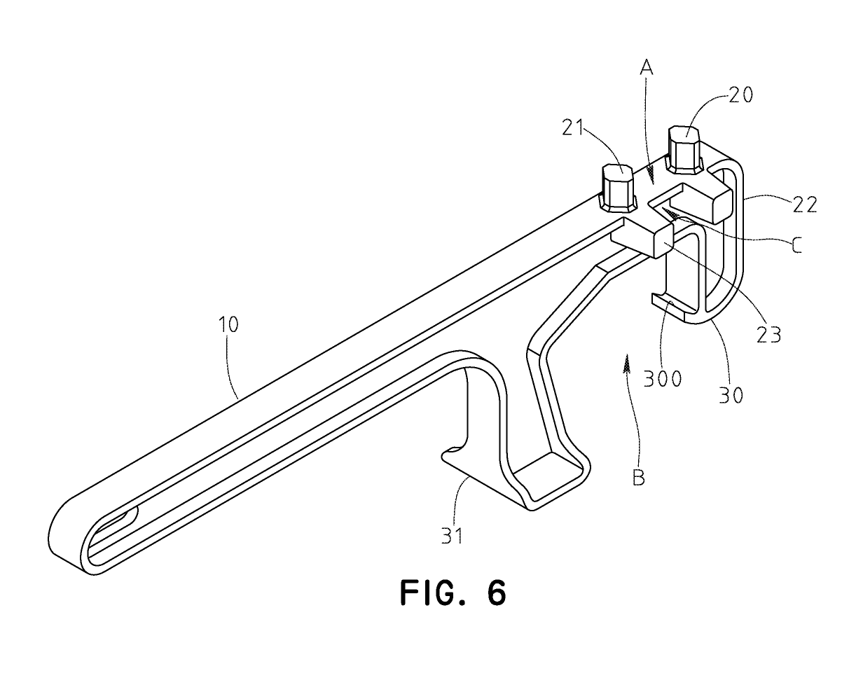

Referring to FIGS. 1 to 7, a universal barrel opener in accordance with a preferred embodiment of the invention is shaped as a bar clamp (or F clamp). The barrel opener is made of, for example, stainless steel and is formed by molding. The barrel opener comprises the following components as discussed in detail below.

An elongated handle 10 is grooved so as to increase its structural strength. A first projection 20 and a parallel second projection 21 rearward of the first projection 20 are provided on a top surface of the handle 10. A gap A is formed between the first projection 20 and second projection 21.

A first protrusion 22 and a parallel second protrusion 23 rearward of the first protrusion 22 are extended from one side of the handle 10. A gap C is formed between the first protrusion 22 and the second protrusion 23. The first protrusion 22 is aligned with the first projection 20 and the second protrusion 23 is aligned with the second projection 21 when viewing from one side of the handle 10.

A prying member 30 and a fulcrum 31 rearward of the prying member 30 are extended downward from a bottom surface of the handle 10. A gap B is formed between the prying member 30 and the fulcrum 31. An open end of the prying member 30 is formed as a hook 300. A protuberance 40 is provided on the other side of the prying member 30 opposing both the first protrusion 22 and the second protrusion 23.

Each of the first projection 20 and the second projection 21 has a cross-section similar to that of a hexagonal prism. Each of the first protrusion 22 and the second protrusion 23 is tapered, truncated and has a cross-section of square. The protuberance 40 is tapered, truncated and has a cross-section of rectangle.

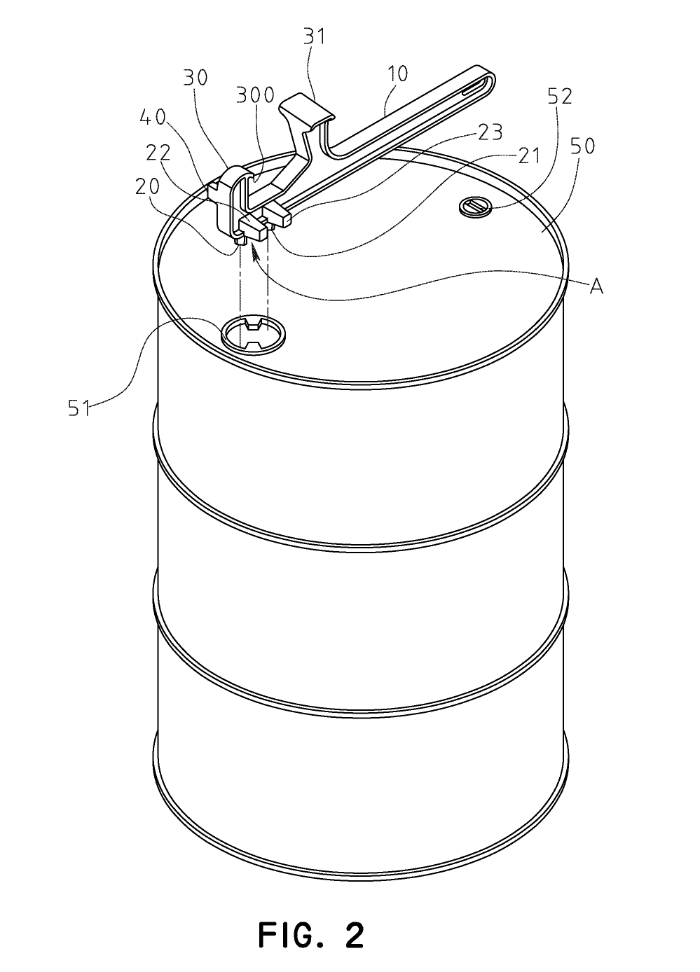

As shown in FIG. 2, the first projection 20 and the second projection 21 together are adapted to open a large first cap 51 on a top of a cylindrical barrel 50.

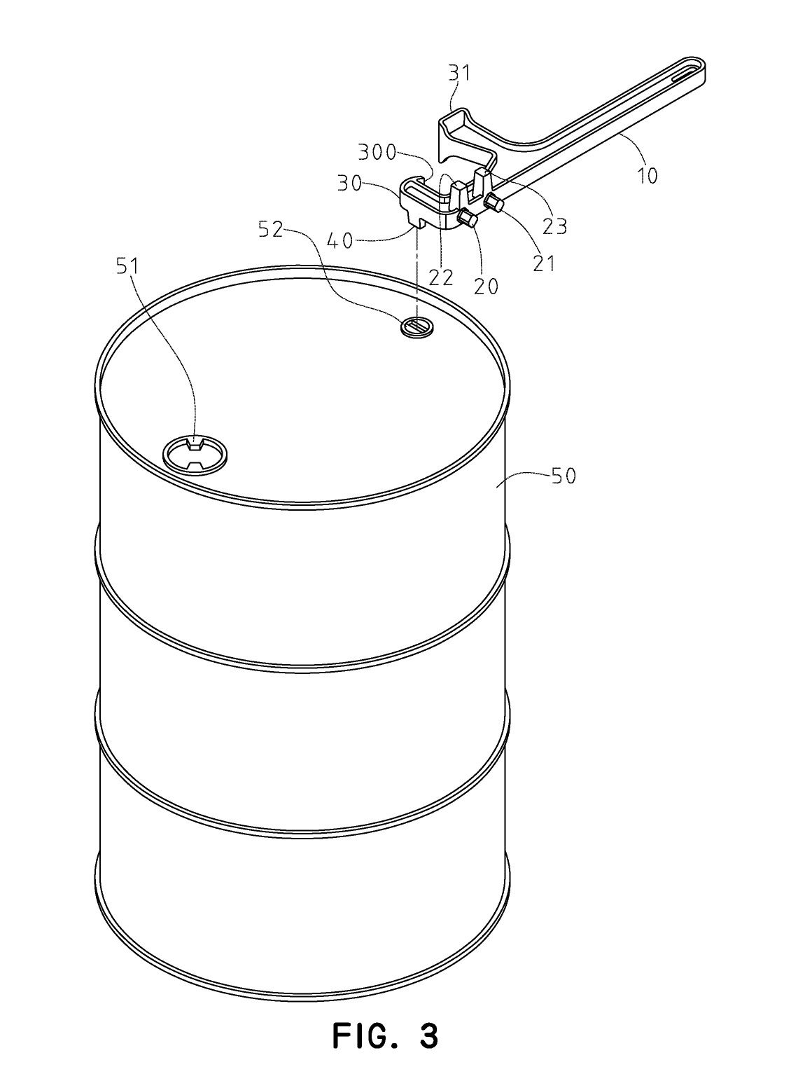

As shown in FIG. 3, the protuberance 40 is adapted to open a small second cap 52 on the top of the barrel 50. A top surface of the second cap 52 is further different from that of the first cap 51.

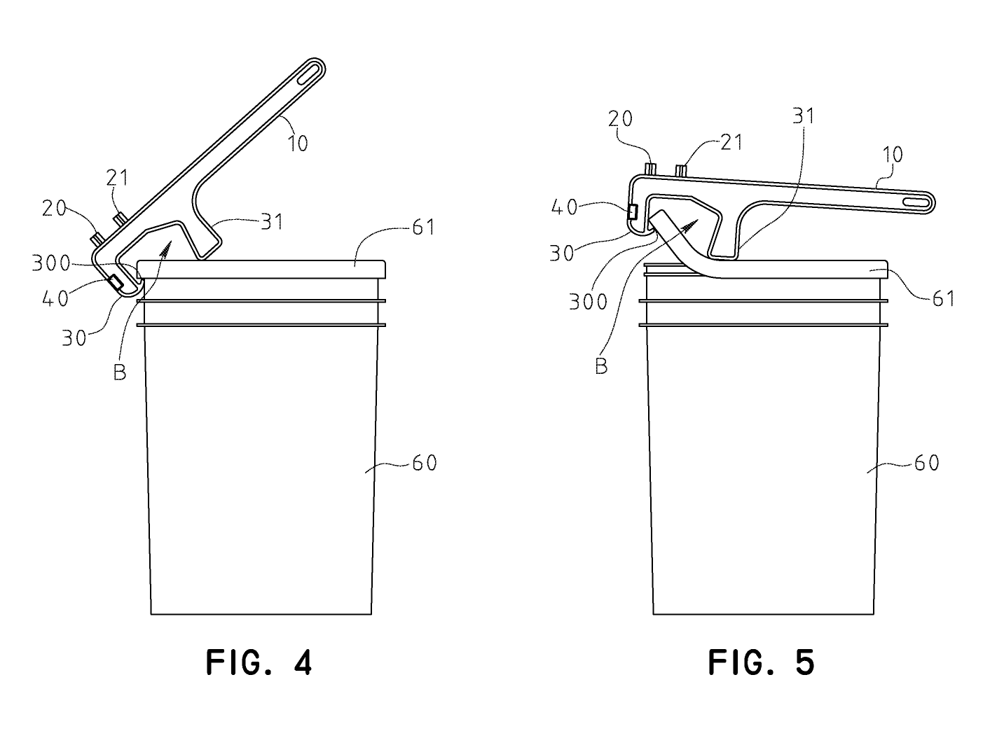

As shown in FIG. 4, the prying member 30 has its hook 300 engaged with a shoulder of a top 61 of another type of barrel 60 and the fulcrum 31 rested upon the top surface of the top 61. Next, as shown in FIG. 5, a person (not shown) may exert a great downward force on the handle 10 to cause the hook 300 to bend the edge of the top 61 upward. As a result, the barrel 60 is open.

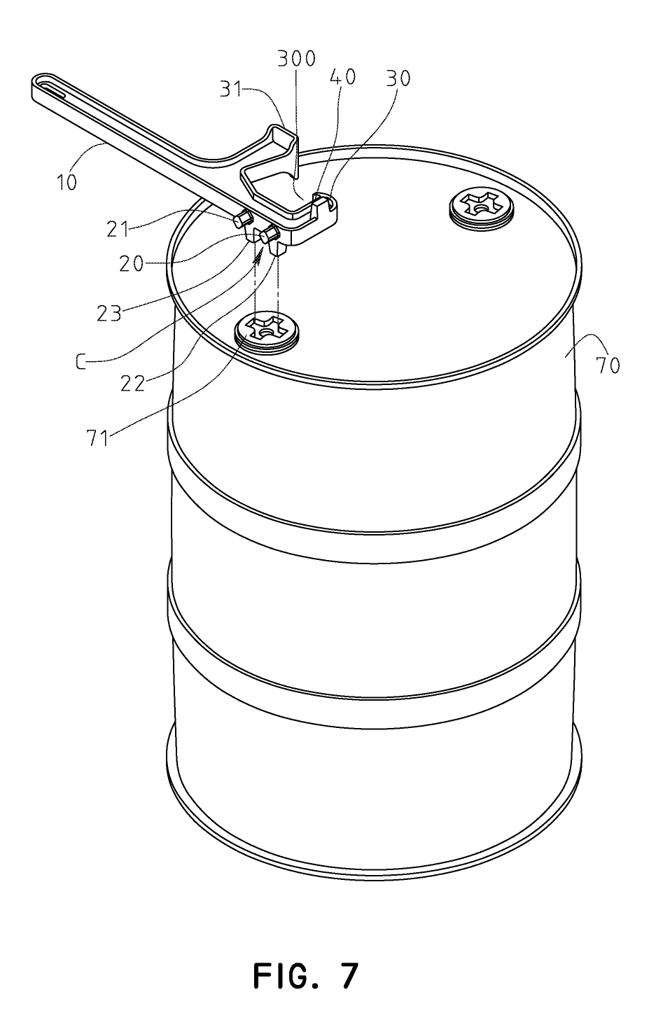

As shown in FIG. 7, the first protrusion 22 and the second protrusion 23 together are adapted to open either one of two identical caps 71 on a top of still another type of barrel 70.

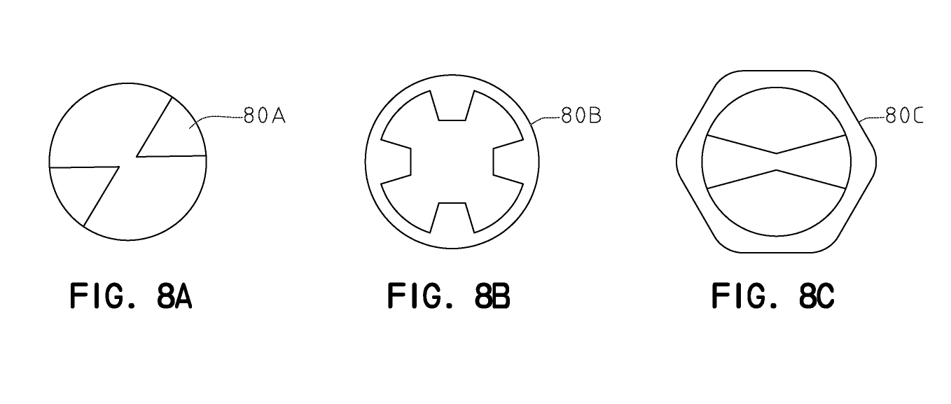

Referring to FIG. 8A, a first type of cap 80A is shown and the cap 80A can be opened or closed by the barrel opener of the invention is shown.

Referring to FIG. 8B, a second type of cap 80B is shown and the cap 80B can be opened or closed by the barrel opener of the invention is shown.

Referring to FIG. 8C, a third type of cap 80C is shown and the cap 80C can be opened or closed by the barrel opener of the invention is shown.

While the invention herein disclosed has been described by means of specific embodiments, numerous modifications and variations could be made thereto by those skilled in the art without departing from the scope and spirit of the invention set forth in the claims.

What is claimed is:

1. An opener for opening a barrel, comprising:
a handle (10);
a first projection (20) disposed on a first surface of the handle (10);
a second projection (21) parallel to the first projection (20) disposed on the first surface of the handle (10);
a first protrusion (22) disposed on one side of the handle (10);
a second protrusion (23) parallel to the first protrusion (22) disposed on one side of the handle (10);
a prying member (30) disposed on a second surface of the handle (10) opposite the first surface of the handle (10), the prying member (30) having an end hook (300);
a fulcrum (31) spaced from the prying member (30) and disposed on the second surface of the handle (10); and
a protuberance (40) disposed on one side of the prying member (30) opposing both the first and second protrusions (22, 23).

2. The opener of claim 1, wherein a distance between the first protrusion (22) and the first projection (20) is substantially equal to that between the second protrusion (23) and the second projection (21).
